(19) United States
(12) Patent Application Publication
(10) Pub. No.: US 2005/0024851 A1
(43) Pub. Date: Feb. 3, 2005

(54) Liquid actuated lighting liquid container

(76) Inventor: Yih Yuh Lee, Shi Sha Town (TW)

Correspondence Address: Raymond Y. Chan, Suite 128, 108 N. Ynez Ave., Monterey Park, CA, 91754, US

(21) Appl. No.: 10/630,024

(22) Filed: Jul. 30, 2003

(51) Int. Cl. F21V 33/00

(52) U.S. Cl. 362/101

(57) ABSTRACT

A liquid actuated lighting liquid container includes a container having a cup body defining a liquid cavity for containing a liquid therein, a cup base, having a storage cavity, extended from the cup body, and two sealing slots communicating the liquid cavity with the storage cavity. A liquid actuated lighting arrangement includes two terminals sealedly disposed in the two sealing slots respectively in a watertight manner, and an illumination unit, which is received in the storage cavity of the cup base, including a circuit electrically connected with the terminals and at least an illuminator electrically mounted on the circuit. Therefore, when the liquid is filled within the liquid cavity of the cup body, the two terminals are electrically connected via the liquid as a conductive media so as to actuate the illuminator to provide a lighting effect on the container.

### BACKGROUND OF THE PRESENT INVENTION

1. Field of Invention

The present invention relates to a liquid container, and more particularly to a liquid actuated lighting liquid container, wherein a liquid actuated lighting arrangement is actuated for providing a lighting effect when liquid is contained in the liquid container.

2. Description of Related Arts

Generally speaking, a liquid container, such as a cup, is characterized by its function that provides thermo ability and its appearance. Conventionally, the appearance type liquid container comprises a cup body having a receiving cavity formed between an outer wall and an inner wall for containing liquid therebetween wherein floating elements are disposed in the receiving cavity in such a manner that when the cup body is shook in an up side down manner, the floating elements are movably floating within the liquid. Therefore, the liquid container provides a dynamic mechanism to get the attention from the user, especially the young child.

However, such liquid container has a major drawback that when water is filled in the cup body, the dynamic mechanism cannot be operated because the cup body is impossible to shake in an up side down manner. In other words, in order to operate the dynamic mechanism, the cup body must be empty to prevent the water spitting out therefrom. In addition, the overall weight of the liquid container will be substantially increased by the liquid within the receiving cavity such that it is unreasonable for the young child to hold the liquid container once the water is filled therein.

Another type of liquid container comprises a lighting device built-in with the cup body for providing a lighting effect to get the attention from the user. The most common lighting device is that when the user lifts up the cup body from the table surface, the lighting device is actuated to provide the lighting effect. Such mechanism of the lighting device can be simply modified by a person who skilled in that art.

Another type of lighting device is actuated when the water is filled in the cup body. Accordingly, the liquid container further comprises a cup base detachably mounted on the bottom of the cup body for receiving the lighting device. The lighting device comprises two terminals extended from the cup base to the cup body in such a manner that when the water is filled in the cup body, the terminals are electrically connected via the water so as to actuate the lighting device.

However, such liquid container has several drawbacks. Since the two terminals are extended to penetrate through the cup body, the water contained in the cup body may leak to the cup base along the terminals to damage the circuit of the lighting device. Moreover, in order to replace the battery, the cup base must be detached from the cup body such that the terminals cannot be permanently connected with the circuit. In other words, the operation of replacing the battery may cause the failure of electrical connection between the terminals and the circuit.

### SUMMARY OF THE PRESENT INVENTION

A main object of the present invention is to provide a liquid actuated lighting liquid container, wherein a liquid actuated lighting arrangement is actuated for providing a lighting effect when liquid is contained in the liquid container.

Another object of the present invention is to provide a liquid actuated lighting liquid container, wherein two terminals are sealedly mounted to the cup body in a watertight manner so as to prevent the leakage of the liquid within the cup body.

Another object of the present invention is to provide a liquid actuated lighting liquid container, wherein the cup base is integrally extended from the cup body to form a one-piece member to avoid the liquid leaking from the cup body to the cup base so as to prevent the circuit from being damaged within the cup base.

Another object of the present invention is to provide a liquid actuated lighting liquid container, which comprises a sealing arrangement provided at each of the terminals not only for preventing the liquid leaking from the cup body along the terminals but also for retaining the terminals in position to electrically connect with the circuit.

Another object of the present invention is to provide a liquid actuated lighting liquid container, wherein the liquid actuated lighting arrangement further comprises two resilient member for applying urging forces against the two terminals respectively so as to ensure the electrical connection the two terminals with the circuit, especially during the battery replacing operation of the present invention.

Another object of the present invention is to provide a liquid actuated lighting liquid container, wherein no expensive or complicated electrical and mechanical structure is employed in the present invention, so as to minimize the manufacturing cost of the liquid container incorporating with the liquid actuated lighting arrangement having two terminals.

Accordingly, in order to accomplish the above objects, the present invention provides a liquid container, comprising:
a container having a cup body defining a liquid cavity for containing a liquid therein, a cup base, having a storage cavity, integrally extended from the cup body, and two sealing slots spacedly extended from the cup body to the cup base to communicate the liquid cavity with the storage cavity; and
a liquid actuated lighting arrangement, comprising:
two terminals disposed in the two sealing slots respectively, wherein each of the terminals has a head portion extended to a position within the liquid cavity and a tail portion extended to a position within the storage cavity;
a sealing arrangement provided at each of the terminals to sealedly mount the terminal within the respective sealing slot in a watertight manner for preventing the liquid within the liquid cavity from leaking to the storage cavity through the sealing slots; and
an illumination unit, which is received in the storage cavity of the cup base, comprising a circuit electrically connected with the terminals and at least an illuminator electrically mounted on the circuit, thereby, when the liquid is filled within the liquid cavity of the cup body, the two terminals are electrically connected via the liquid so as to actuate the illuminator to provide a lighting effect on the container.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a liquid actuated lighting liquid container according to a preferred embodiment of the present invention.

FIG. 2 is an exploded view of the liquid actuated lighting liquid container according to the above preferred embodiment of the present invention.

FIG. 3 is a perspective view of the liquid actuated lighting arrangement of the liquid actuated lighting liquid container according to the above preferred embodiment of the present invention.

FIG. 4 is a sectional view of the liquid actuated lighting liquid container according to the above preferred embodiment of the present invention.

FIG. 5 illustrates an alternative mode of the liquid actuated lighting liquid container according to the above preferred embodiment of the present invention.

### DETAILED DESCRIPTION OF THE PREFERRED EMBODIMENT

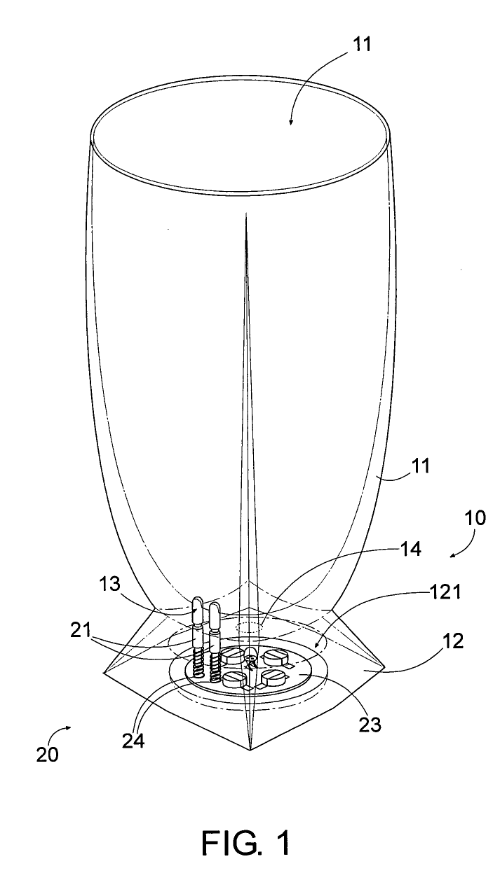

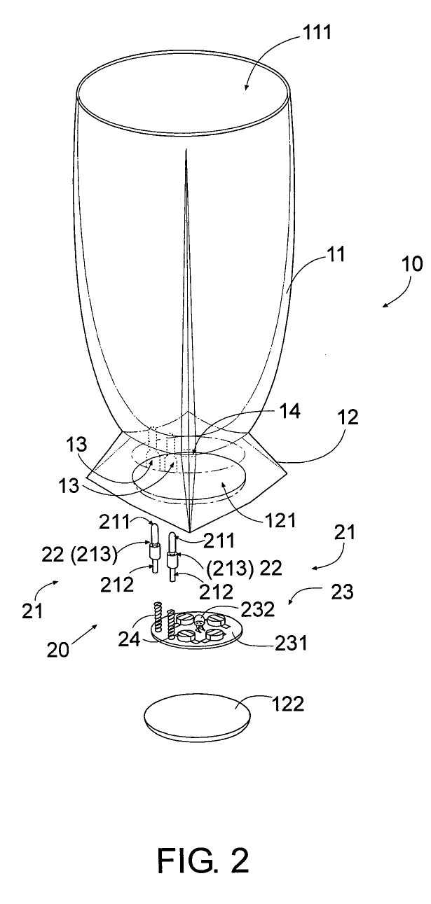

Referring to FIGS. 1 and 2 of the drawings, a liquid actuated lighting liquid container according to a preferred embodiment of the present invention is illustrated, wherein the liquid actuated lighting liquid container comprises a container 10 and a liquid actuated lighting arrangement 20.

The container 10 has a cup body 11 defining a liquid cavity 111 for containing a liquid L therewith, a cup base 12, having a storage cavity 121, downwardly extended from the cup body 11, and two sealing slots 13 spacedly extended from the cup body 11 to the cup base 12 to communicate the liquid cavity 111 with the storage cavity 121.

The liquid actuated lighting arrangement 20 comprises two terminals 21, a sealing arrangement 22, and an illumination unit 23.

The two terminals 21 are disposed in the two sealing slots 13 respectively, wherein each of the terminals 21 has a head portion 211 extended to a position within the liquid cavity 111 and a tail portion 212 extended to a position within the storage cavity 121.

The sealing arrangement 22 is provided at each of the terminals 21 to sealedly mount the terminal 21 within the respective sealing slot 13 in a watertight manner for preventing the liquid L within the liquid cavity 111 from leaking to the storage cavity 121 through the sealing slots 13.

The illumination unit 23, which is received in the storage cavity 121 of the cup base 12, comprises a circuit 231 electrically connected with the terminals 21 and at least an illuminator 232 electrically mounted on the circuit 231, thereby, when the liquid L is filled within the liquid cavity 111 of the cup body 11, the two terminals 21 are electrically connected via the liquid L so as to actuate the illuminator 232 to provide a lighting effect on the container 10.

According to the preferred embodiment, the container 10 is preferably made of transparent material such as plastic that the light from the illumination unit 23 is capable of passing through the cup base 12 towards the cup body 11 for the lighting effect so as to enhance the aesthetic appearance of the liquid container of the present invention. Accordingly, the cup base 12 is integrally extended from the cup body 11 to form a one-piece container 10.

The two terminals 21, which are made of conductive material such as metal for electrical connection, are mounted within the sealing slots 13 respectively at a position between the cup body 11 and the cup base 12. The two terminals 21, which are embodied as a positive charged terminal and a negative charged terminal respectively, are adapted to be electrically connected through a low conductive media in such a manner that when the liquid L is filled in the cup body 11 as a conductive media to contact with the terminals 21, the terminals 21 are electrically connected to provide a closed circuit of the illumination unit 23 so as to actuate the illuminator 231 to provide the lighting effect for the container 10.

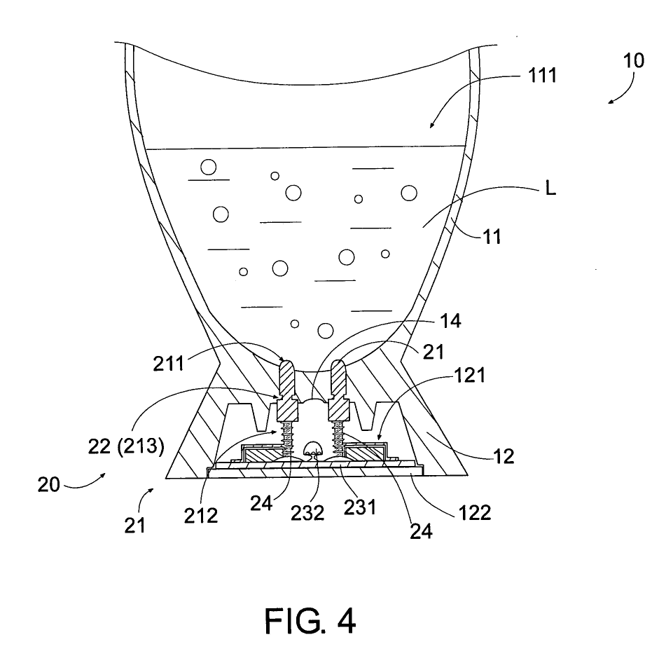

Accordingly, the head portion 211 of each of the terminals 21 is protruded from a bottom wall of the liquid cavity 111 of the cup body 11 for contacting with the liquid L therewith wherein the tail portion 212 of each of the terminals 21 is protruded from a ceiling of the storage cavity 121 of the cup base 12 to electrically connect to the circuit 231 of the illumination unit 23, as shown in FIG. 4.

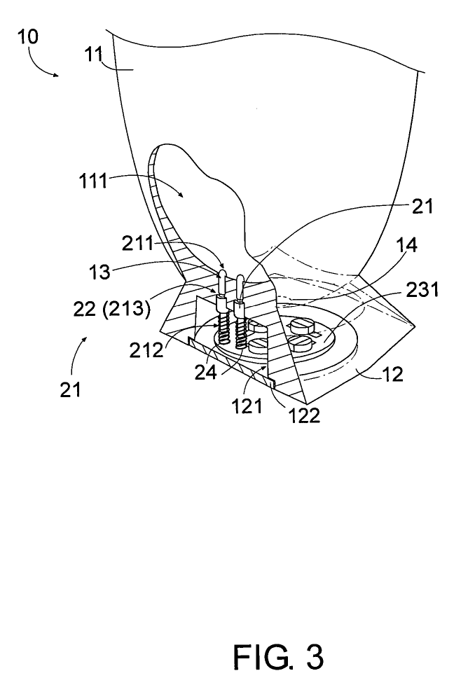

Referring to FIG. 3, the sealing arrangement 22 is provided at a neck portion 213 of each of the terminals 21 between the head portion 211 and the tail portion 212 wherein a diameter of the neck portion 213 of the terminal 21 is smaller than a diameter of each of the head and tail portions 211, 212 of the terminal 21 to fittingly mount within the respective sealing slot 13 so as to sealedly retain the terminals 21 in a watertight manner. Accordingly, each of the sealing slots 13 having a corresponding shaped is sealedly surround the neck portion 213 of the respective terminal 21 to enclose the terminal 21 between the cup body 11 and the cup base 12 in a watertight manner so as to prevent the liquid L leaking from the liquid cavity 111 to the storage cavity 121 through the sealing slots 13.

It is worth to mention that the container 10 can be made by conventional injection molding techniques wherein the terminals 21 are fit into the die body in such a manner that while manufacturing the container 10 the during the injection molding process, the terminals 21 are permanently mounted to the container 10 to form the sealing slots 13 fittingly surrounded the terminals 21 respectively, as shown in FIG. 3.

Accordingly, the sealing arrangement 22 not only substantially prevents the liquid L leaking from the liquid cavity 111 to the storage cavity 121 through the sealing slots 13 but also securely retains the terminals 21 in position to prevent an unwanted movement of each of the terminals 21 with respect to the sealing slot 13.

The circuit 231 of the illumination unit 23, which comprises a battery holder for receiving a replaceable battery, is a low conductivity circuit which is adapted to be actuated through a very low current. In other words, when the liquid L, such as water, is filled in the liquid cavity 111 of the cup body 11, the liquid L functions as a conductive element to electrically connect the terminals 21 so as to actuate the circuit 231 of the illumination unit 23. It is worth to mention that since the circuit 231 requires a very low current to be actuated, which is lower than the electrode current of the liquid L, the electrode composition of the liquid L will not occur for safety purpose.

The illuminator 232 is electrically mounted on the circuit 231 for producing the lighting effect, such as flashing. Accordingly, the illuminator 232 is a LED having at least two diodes to enhance the lighting effect by electrifying the diodes. In other words, the illuminator 232 is capable of producing different colors when the diodes are electrified respectively.

According to the preferred embodiment, the circuit 231 is preset to activate the illuminator 232 for providing the lighting effect when the liquid L is filled in the cup body 11 to contact with the terminals 21. The circuit 231 is deactivated when the cup body 11 is empty. In other words, no lighting effect is provided when the liquid container of the present invention is unused. Alternatively, the circuit 231 is adapted to be preset to activate the illuminator 231 for a predetermined time period such that the illuminator 231 will provide the lighting effect for the preset time period once the liquid L is filled in the cup body 11.

As shown in FIG. 2, the storage cavity 121 is provided at a bottom side of the cup base 12 wherein the cup base 12 further comprises a cover 122 detachably mounted on the bottom side of the cup base 12 to enclose the storage cavity 121. Therefore, the user is able to replace the battery by detaching the cover 122 from the bottom side of the cup base 12 and by taking the circuit 231 out of the storage cavity 121.

Accordingly, in order to ensure the electrical connection between the terminals 21 and the circuit 231, the liquid actuated lighting arrangement 20 further comprises two resilient members 24 electrically extended from the circuit 231 for applying an urging force against the terminals 21 respectively, so as to electrically connect the two terminals 21 with the circuit 231. As shown in FIG. 4, each of the resilient members 24 is a compression spring having two ends respectively biasing against the circuit 231 and the respective terminal 21 to ensure the electrical connection between the circuit 231 and the terminals 21.

According to the preferred embodiment, the tail portion 212 of each of the terminals 21 is shaped as a spring holder to slidably insert into one end of the respective resilient member 24 while another end thereof is electrically mounted on the circuit 231 to electrically connect the terminals 21 with the circuit 231. Therefore, after the operation of replacing the battery, the user is able to alignedly insert the tail portions 212 of the two terminals 21 into the two resilient members 24 and to pull the circuit 231 back into the storage cavity 121 of the cup base 12. In other words, the compression force of each of the resilient members 24 ensures the electrical connection between the circuit 231 and the respective terminal 21.

In order to enhance the lighting effect of the illumination unit 23, the container 10 further has a magnifying lens 14 integrally formed on the ceiling of the storage cavity 12 at a position aligning with the illuminator 232 for magnifying the light from the illuminator 232 throughout the cup body 11, as shown in FIG. 4. Accordingly, when the illuminator 232 produces the light once the liquid L is filled in the cup body 11, the magnifying lens 14 is arranged to magnify the light to distribute towards the cup body 11 so as to enhance the lighting effect of the liquid actuated lighting liquid container of the present invention.

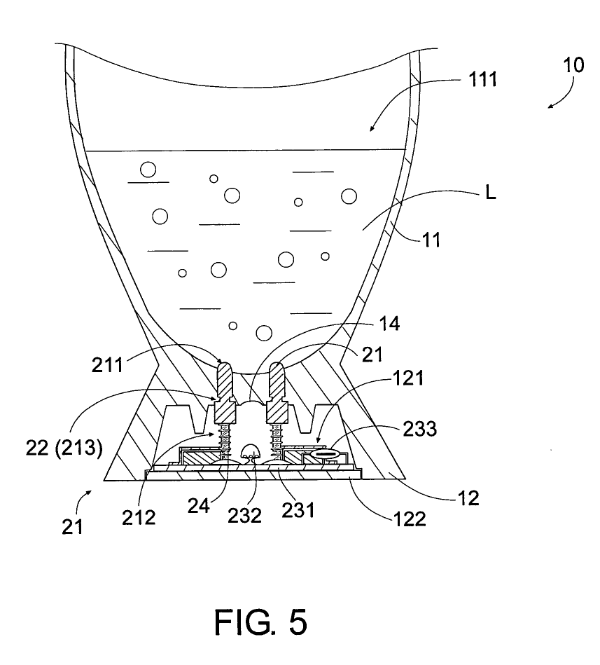

In view of above, the liquid actuated lighting liquid container of the present invention can be simply modified via the illumination unit 23. As shown in FIG. 5, the illumination unit 23 further comprises a control switch 233 electrically mounted on the circuit 231 for controlling the illuminator 232 in an on and off manner. Preferably, the control switch 233 is embodied as a motion sensing switch that when the control switch 233 detects the motion of the container 10, the illuminator 232 is automatically switched on to provide the lighting effect. In other words, when the liquid L is filled in the cup body 11, the illuminator 232 is activated through the terminals 21 once the user picks up the container 10 to provide the motion thereof.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

1. A liquid actuated lighting liquid container, comprising:
a container having a cup body defining a liquid cavity for containing a liquid therein, a cup base, having a storage cavity, downwardly extended from said cup body, and two sealing slots spacedly extended from said cup body to said cup base to communicate said liquid cavity with said storage cavity; and
a liquid actuated lighting arrangement, comprising:
two terminals disposed in said two sealing slots respectively, wherein each of said terminals has a head portion extended to a position within said liquid cavity and a tail portion extended to a position within said storage cavity;
a sealing arrangement provided at each of said terminals to sealedly mount said terminal within said respective sealing slot in a watertight manner for preventing said liquid within said liquid cavity from leaking to said storage cavity through said sealing slots; and
an illumination unit, which is received in said storage cavity of said cup base, comprising a circuit electrically connected with said terminals and at least an illuminator electrically mounted on said circuit, thereby, when said liquid is filled within said liquid cavity of said cup body, said two terminals are electrically connected via said liquid as a conductive media so as to actuate said illuminator to provide a lighting effect on said container.

2. A liquid actuated lighting liquid container, as recited in claim 1, wherein said sealing arrangement is provided at a neck portion of each of said terminals between said head portion and said tail portion, wherein a diameter of said neck portion of said terminal is smaller than a diameter of each of said head and tail portions of said terminal, wherein each of said sealing slots having a corresponding shaped is sealedly surround said neck portion of said respective terminal so as to sealedly enclose said terminal between said cup body and said cup base in a watertight manner.

3. A liquid actuated lighting liquid container, as recited in claim 1, wherein said liquid actuated lighting arrangement further comprises two resilient members electrically extended from said circuit for applying urging forces against said terminals respectively, so as to electrically connect said two terminals with said circuit.

4. A liquid actuated lighting liquid container, as recited in claim 2, wherein said liquid actuated lighting arrangement further comprises two resilient members electrically extended from said circuit for applying urging forces against said terminals respectively, so as to electrically connect said two terminals with said circuit.

5. A liquid actuated lighting liquid container, as recited in claim 3, wherein each of said resilient members is a compression spring having two ends respectively biasing against said circuit and said respective terminal to electrically connect said terminals with said circuit.

6. A liquid actuated lighting liquid container, as recited in claim 4, wherein each of said resilient members is a compression spring having two ends respectively biasing against said circuit and said respective terminal to electrically connect said terminals with said circuit.

7. A liquid actuated lighting liquid container, as recited in claim 5, wherein said tail portion of each said terminal is shaped as a spring holder to slidably insert into one of said ends of said respective resilient member while another said end thereof is electrically mounted on said circuit.

8. A liquid actuated lighting liquid container, as recited in claim 6, wherein said tail portion of each said terminal is shaped as a spring holder to slidably insert into one of said ends of said respective resilient member while another said end thereof is electrically mounted on said circuit.

9. A liquid actuated lighting liquid container, as recited in claim 2, wherein said cup base is integrally extended from said cup body to form said container having a one-piece integral structure, wherein said storage cavity is provided at a bottom side of said cup base to receive said illumination unit therein.

10. A liquid actuated lighting liquid container, as recited in claim 4, wherein said cup base is integrally extended from said cup body to form said container having a one-piece integral structure, wherein said storage cavity is provided at a bottom side of said cup base to receive said illumination unit therein.

11. A liquid actuated lighting liquid container, as recited in claim 8, wherein said cup base is integrally extended from said cup body to form said container having a one-piece integral structure, wherein said storage cavity is provided at a bottom side of said cup base to receive said illumination unit therein.

12. A liquid actuated lighting liquid container, as recited in claim 4, wherein said two terminals are embodied as a position charged terminal and a negative charged terminal respectively, wherein said two terminals are adapted for being electrically connected through a low conductive media.

13. A liquid actuated lighting liquid container, as recited in claim 8, wherein said two terminals are embodied as a position charged terminal and a negative charged terminal respectively, wherein said two terminals are adapted for being electrically connected through a low conductive media.

14. A liquid actuated lighting liquid container, as recited in claim 11, wherein said two terminals are embodied as a position charged terminal and a negative charged terminal respectively, wherein said two terminals are adapted for being electrically connected through a low conductive media.

15. A liquid actuated lighting liquid container, as recited in claim 4, wherein said circuit of said illumination unit, which comprises a battery holder for receiving a replaceable battery to electrically connect to said illuminator, is a low conductivity circuit adapted to be actuated through a very low current with respect to an electrode current of said liquid.

16. A liquid actuated lighting liquid container, as recited in claim 8, wherein said circuit of said illumination unit, which comprises a battery holder for receiving a replaceable battery to electrically connect to said illuminator, is a low conductivity circuit adapted to be actuated through a very low current with respect to an electrode current of said liquid.

17. A liquid actuated lighting liquid container, as recited in claim 11, wherein said circuit of said illumination unit, which comprises a battery holder for receiving a replaceable battery to electrically connect to said illuminator, is a low conductivity circuit adapted to be actuated through a very low current with respect to an electrode current of said liquid.

18. A liquid actuated lighting liquid container, as recited in claim 4, wherein said container further has a magnifying lens integrally formed on a ceiling of said storage cavity at a position aligning with said illuminator for magnifying a light from said illuminator throughout said cup body.

19. A liquid actuated lighting liquid container, as recited in claim 8, wherein said container further has a magnifying lens integrally formed on a ceiling of said storage cavity at a position aligning with said illuminator for magnifying a light from said illuminator throughout said cup body.

20. A liquid actuated lighting liquid container, as recited in claim 11, wherein said container further has a magnifying lens integrally formed on a ceiling of said storage cavity at a position aligning with said illuminator for magnifying a light from said illuminator throughout said cup body.
